(19) United States
(12) Patent Application Publication
(10) Pub. No.: US 2014/0353410 A1
(43) Pub. Date: Dec. 4, 2014

(54) Spray Fixture System

(71) Applicant: Finishing Brands Holdings Inc., Minneapolis, MN (US)

(72) Inventors: Steven Andrew Myers, Scottsdale, AZ (US); Payton Xavier Cozart, Uniontown, OH (US); Kyle F.M. Miller, Temperance, MI (US)

(73) Assignee: Finishing Brands Holdings Inc., Minneapolis, MN (US)

(21) Appl. No.: 14/267,681

(22) Filed: May 1, 2014

Related U.S. Application Data
(60) Provisional application No. 61/831,129, filed on Jun. 4, 2013.

(51) Int. Cl. B05B 5/053

(52) U.S. Cl. CPC B05B 5/0533
USPC 239/690

(57) ABSTRACT

A system including an electrostatic spray fixture system, including a non-conductive frame surrounding an aperture, wherein the non-conductive frame is configured to retain an object within the aperture, and a conductor coupled to the frame, wherein the conductor is configured to electrically couple to the object within the aperture, and the non-conductive frame comprises a non-conductive material to reduce electrostatic attraction of an electrically charged coating material.

### CROSS-REFERENCE TO RELATED APPLICATION

This application is a Non-Provisional application and claims priority to U.S. Provisional Patent Application No. 61/831,129, entitled “Spray Fixture System”, filed Jun. 4, 2013, which is herein incorporated by reference.

### BACKGROUND

The invention relates generally to a system and method of coating an object with an electrostatic spray.

Electrostatic tools spray electrically charged materials to more efficiently coat objects. For example, electrostatic tools may be used to paint objects. In operation, a grounded target attracts electrically charged materials sprayed from an electrostatic tool. As the electrically charged material contacts the grounded target, the material loses the electrical charge. However, the electrical attractiveness of neighboring components may inhibit electrostatic spraying of small objects.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system including an electrostatic spray fixture system, including a non-conductive frame surrounding an aperture, wherein the non-conductive frame is configured to retain an object within the aperture, and a conductor coupled to the frame, wherein the conductor is configured to electrically couple to the object within the aperture, and the non-conductive frame comprises a non-conductive material to reduce electrostatic attraction of an electrically charged coating material.

In another embodiment, a system including an electrostatic spray fixture system, including a non-conductive frame surrounding an aperture, a conductor coupled to the frame, wherein the conductor is configured to electrically couple to the object within the aperture, and the non-conductive frame comprises a non-conductive material to reduce electrostatic attraction of an electrically charged coating material, and a first retaining member configured to retain the object within the aperture.

In another embodiment, a system including an electrostatic spray fixture, including a non-conductive frame surrounding an aperture, wherein the non-conductive frame is configured to retain an object within the aperture, a conductor coupled to the frame, wherein the conductor is configured to electrically couple to the object within the aperture, and the non-conductive frame comprises a non-conductive material to reduce electrostatic attraction of an electrically charged coating material, and a spindle electrically coupled to the conductor and configured to ground the conductor.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of an embodiment of an electrostatic spray system with a spray fixture system;

FIG. 2 is a front perspective view of an embodiment of a spray fixture system;

FIG. 3 is a rear perspective view of an embodiment of a spray fixture system;

FIG. 4 is a front perspective view of an embodiment of a spray fixture system;

FIG. 5 is a rear perspective view of an embodiment of a spray fixture system;

FIG. 6 is a rear perspective view of an embodiment of a spray fixture system; and

FIG. 7 is a rear perspective view of an embodiment of a spray fixture system.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed towards a spray fixture system that facilitates electrostatic spraying of a target. The spray fixture system may improve electrostatic coating by focusing the electrical attraction of the coating material towards the target by reducing the electrical attraction (i.e., interference) of neighboring components. Specifically, the embodiments below describe a non-conductive frame (e.g., non-electrically conductive, electrically insulative) capable of securing a target within an aperture of the frame. The non-conductive frame's resistance to the flow of current makes the frame less electrically attractive to the electrically charged coating material than the target. Accordingly, during spraying operations, the non-conductive frame improves the coating of a target by blocking or reducing the flow of electrostatically charged coating material away from the electrically attractive target. The embodiments below describe multiple ways of securing a target within the aperture, while reducing or blocking electrical attraction away from the target. For example, the spray fixture system may include non-conductive magnets (e.g., non-electrically conductive, electrically insulative) that secure a target within the non-conductive frame while simultaneously blocking or reducing electric attraction away from the target. In another embodiment, the spray fixture system may include clips that secure the target to the non-conductive frame. In still other embodiments, the target may be compressively retained against the non-conductive frame with blocks or secured within apertures of the blocks.

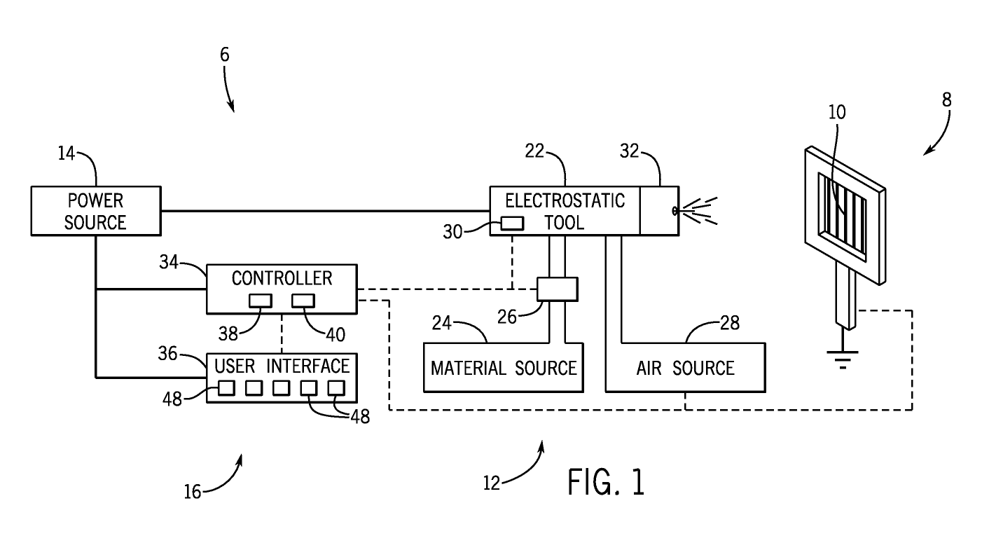

FIG. 1 is a schematic of an electrostatic spray system 6 capable of spraying an electrostatically charged coating material to coat products (implantable medical devices, syringe needles, stents, guide wires, catheters, etc.) held in a spray fixture system 8. The spray fixture system 8 improves target coating by reducing or blocking the attraction of the electrostatically charged coating material away from the intended targets 10. As will be explained in more detail below, the spray fixture 8 includes nonconductive components arranged in a way that reduces the attraction of the electrostatic coating material to conductive components that electrically ground the targets 10.

The electrostatic spray system 6 includes a material delivery system 12, a power source 14, and a controller system 16. These systems operate together to spray an electrically charged coating material onto the targets 10. The material delivery system 12 includes an electrostatic tool 22 (e.g., spray device), a material source 24 (e.g., fluid tank), a material delivery component 26, and an air source 28 (e.g., air tank and/or compressor). In operation, the electrostatic spray system 6 uses the power source 14 to power the material delivery system 12. The electrostatic tool 22 receives power from the power source 14, material (e.g., liquid) from the material source 24, and airflow from the air source 28. The electrostatic tool 22 combines the power, the coating material, and the airflow to spray the electrically charged coating material (e.g., a liquid spray). Specifically, the electrostatic tool 22 electrically charges, atomizes, and sprays (e.g., a liquid spray) the coating material (e.g., liquid) onto the targets 10. The material delivery system 12 may include the material delivery component 26 to facilitate movement of the coating material into the electrostatic tool 22. The material delivery component 26 may be a pressure pot, a syringe pump, or another kind of pump capable of delivering the coating material to the electrostatic tool 22.

In the illustrated example, the electrostatic tool 22 may be a gas spray gun (e.g., a spray gun that sprays air or another type of gas) with a spray tip assembly 32 and a voltage multiplier 30. For example, the electrostatic tool may use a gas to atomize and/or shape the liquid spray. In order to electrically charge the coating material, the electrostatic tool 22 includes the voltage multiplier 30. The voltage multiplier 30 receives the power from the power source 14. The power source 14 may be an external power source (e.g., power grid, electrical generator etc.), an internal power source (e.g., a battery or electrical generator), or a combination of an external power source and an internal power source. The voltage multiplier 30 receives power from the power source 14 and converts the power to a higher voltage to be applied to the coating material in the electrostatic tool 22. As will be appreciated, the voltage multiplier 30 may be removable and may include diodes and capacitors. In certain embodiments, the voltage multiplier 30 may also include a switching circuit that changes the power between a positive and a negative voltage. As the coating material atomizes and charges, the coating material is sprayed onto the targets 10 (e.g., guide wires, catheters, etc.). The targets 10 may be grounded or oppositely charged to electrically attract the coating material.

As shown in FIG. 1, the electrostatic spray system 6 includes the controller system 16. The controller system 16 includes a controller 34 and user interface 36, which may be powered by the power source 14. As illustrated, the controller 34 includes a processor 38 and a memory 40. The memory 40 may store instructions (i.e., software code) executable by the processor 38 to control operation of the electrostatic spray system 6. The controller 34 may couple to the material delivery system 12 and the spray fixture system 8 to control various parameters. For example, the controller 34 may control the flow of material from the material source 24, airflow from the airflow source 28, the amount of electrical charge added to the material exiting the electrostatic tool 22 with the voltage multiplier 30, and the polarity of the spray fixture system 8.

The user interface 36 connects to and receives information from the controller 34. In certain embodiments, the user interface 36 may be configured to allow a user to adjust various settings and operating parameters based on information collected by the controller 34. Specifically, the user may adjust settings or parameters with a series of buttons or knobs 48 coupled to the user interface 36. In certain embodiments, the user interface 34 may include a touch screen that enables both user input and display of information relating to the electrostatic spray system 6. For example, the user interface 36 may enable a user to adjust the voltage supplied by the voltage multiplier 30, turn the voltage on/off, and adjust the amount of material sprayed by the tool 12 using a knob, dial, button, or menu on the user interface 34. Moreover, the user interface 34 may include preprogrammed operating modes for an electrostatic spray system 6. These modes may be processes that change the electric charge added to a sprayed material over a period of time or that change the amount of material sprayed by the electrostatic system 10. An operator may activate one or more operating modes using a button, knob, dial, or menu 48 on the user interface 34. These preprogrammed operating modes may be a specific process for manufacturing a product, a specific step in a process, or may correspond to operating parameters for the electrostatic spray system 6 (e.g., voltage level, material discharge rate, airflow rate, etc.). For example, the modes may include operating modes that are customized to a specific product (e.g., stent, guide wire, or catheter and/or a specific coating material (e.g., PTFE).

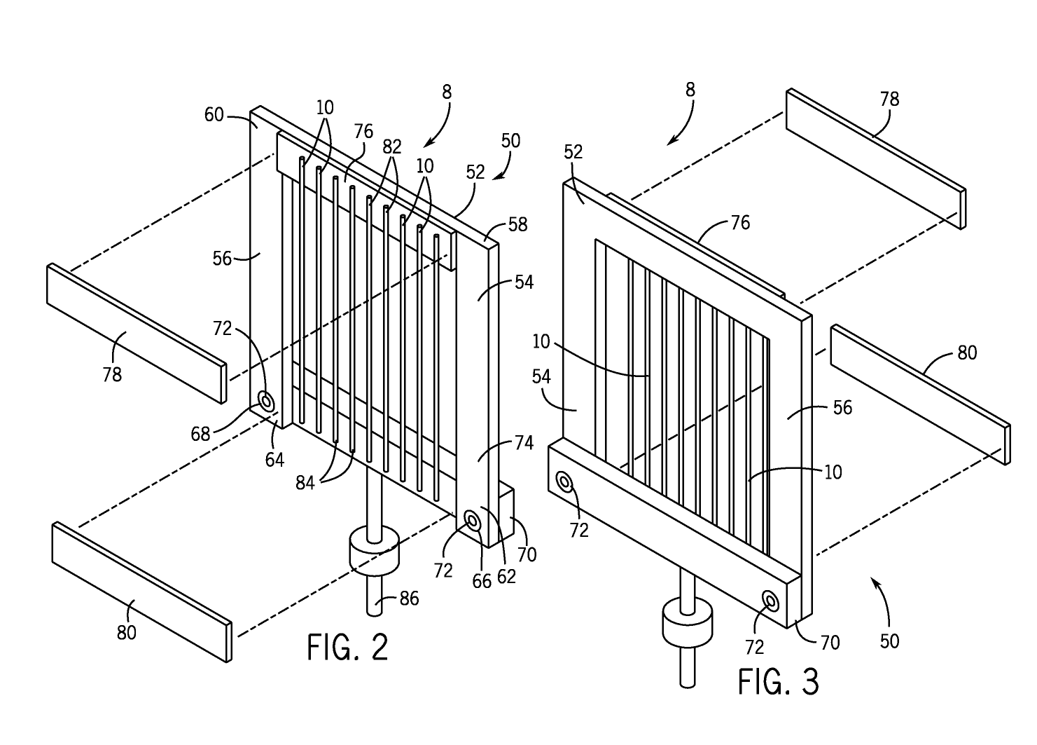

FIG. 2 is a front perspective view of an embodiment of a spray fixture system 8 that increases the electrical attraction of the targets 10 by reducing or blocking the attraction of an electrically charged coating material towards other components. For example, the targets 10 may have a small cross-sectional area that limits the electrical attractiveness (e.g., a small medical device such as a stent, a guide wire, a catheter, etc.). In order to focus the electrically charged coating material towards the targets 10, the spray fixture system 8 includes a non-conductive frame 50 made out of a non-conductive material (e.g., non-electrically conductive, electrically insulative), such as a polymer, a wood, a ceramic, a non-conductive metal, a composite, or any combination thereof. For example, the polymer may include an elastomer or rubber, nylon, polyvinyl chloride (PVC), polystyrene, polyethylene, polypropylene, silicone, neoprene, or any combination thereof. The composite material may include a fiber reinforced polymer, a ceramic composite or other matrix material with a distributed reinforcing material (e.g., fibers). As illustrated, the frame 50 includes three sides 52, 54, and 56. The sides 52, 54, and 56 may be integrally formed or separate but capable of coupling together to form the frame 50. The sides 54 and 56 define first ends 58 and 60 that couple to the side 52, and second ends 62 and 64. The second ends 62 and 64 may include apertures 66 and 68 that enable the sides 54 and 56 to couple to a conductive member 70 with connectors 72 (e.g., bolts, screws, pins). When the sides 52, 54, and 56 couple together and to the conductive member 70 they form an aperture 74. In the present embodiment, the aperture 74 is a square. However, in other embodiments, the frame 50 and conductive member 70 may form a variety of aperture 74 shapes (e.g., circle, semi-circle, rectangle, trapezoidal, triangular, pentagonal, etc.).

As illustrated, the targets 10 are suspended within the aperture 74 between the side 52 and the electrically conductive member 70. Specifically, the targets 10 are suspended with non-conductive magnets 76, 78, and 80 (e.g., non-electrically conductive, electrically insulative) within the aperture 74. In one embodiment, a first non-conductive magnet 76 may couple to the side 52 on the front face of the frame 50 with an adhesive or mechanical fasteners (e.g., bolts, screws, etc.). The non-conductive magnet 76 attracts a first end 82 of the targets 10 and the non-electrically conductive magnet 78. In this arrangement, the first end 82 of the targets 10 are compressively held in place between the two magnets 76 and 78. In some embodiments the magnet 76 may be replaced with a conductive material similar to the conductive member 70 enabling magnet 78 to compressively retain the ends 82 of the targets 10 to the frame 50. The second end 84 of the targets 10 are similarly retained, but between the conductive member 70 and the non-conductive magnet 80. In this manner, both the first ends 82 and the second ends 84 of the targets 10 are compressively retained within the aperture 74 and electrically grounded through contact with the conductive member 70. In another embodiment, the member 70 may be non-conductive but include a conductive coating to enable grounding of the targets 10.

As illustrated, the non-conductive magnet 80 covers the conductive member 70 to reduce or block attraction of the electrostatically charged coating material towards the conductive member 70. The conductive member 70 may be otherwise grounded or charged making the conductive member 70 electrically attractive to an electrically charged coating material. For example, the conductive member 70 may couple to a grounded spindle 86 enabling the electrostatically charged coating material to lose charge after the coating material contacts the targets 10. In other embodiments, the targets 10 may be charged with an opposite electric charge, relative to the change applied to the coating material, through contact with the conducting member 70. Accordingly, without the non-conductive magnet 80, the electrostatically charged coating material may be electrically attracted to the conductive member 70 and therefore attract the coating material away from the targets 10. By covering the conductive member 70, with the non-conductive magnet 80 the non-conductive magnet 80 blocks or reduces the electrical attraction of the conductive member 70, while increasing the electrical attraction of the targets 10.

FIG. 3 is a rear perspective view of an embodiment of a spray fixture system 8. As illustrated, the conductive member 70 attaches to the rear of the non-conductive frame 50 with connectors 72. However, in other embodiments, the conductive member 70 may couple to the front of the non-conductive frame 50. In an embodiment where the conductive member 70 couples to the front of the frame 50, the magnet 80 may extend over the sides 56 and 54, covering the entire conductive member 70. By extending from side 56 to side 54, the non-conductive magnet 80 covers the connectors 72, which blocks attraction of the electrostatically charged coating material toward the connectors 72. Moreover, in the present embodiment, the non-conductive magnets 76 and 78 are on the front of the frame 50. In other embodiments, the non-conductive magnets 76 and 78 may be placed on the rear side of the non-conductive frame 50. The placement of the magnets 76 and 78 on the rear side of the non-conductive frame 50 may improve usability of the spray fixture system 8 by blocking or reducing contact between the magnets 76 and 78 and the coating material.

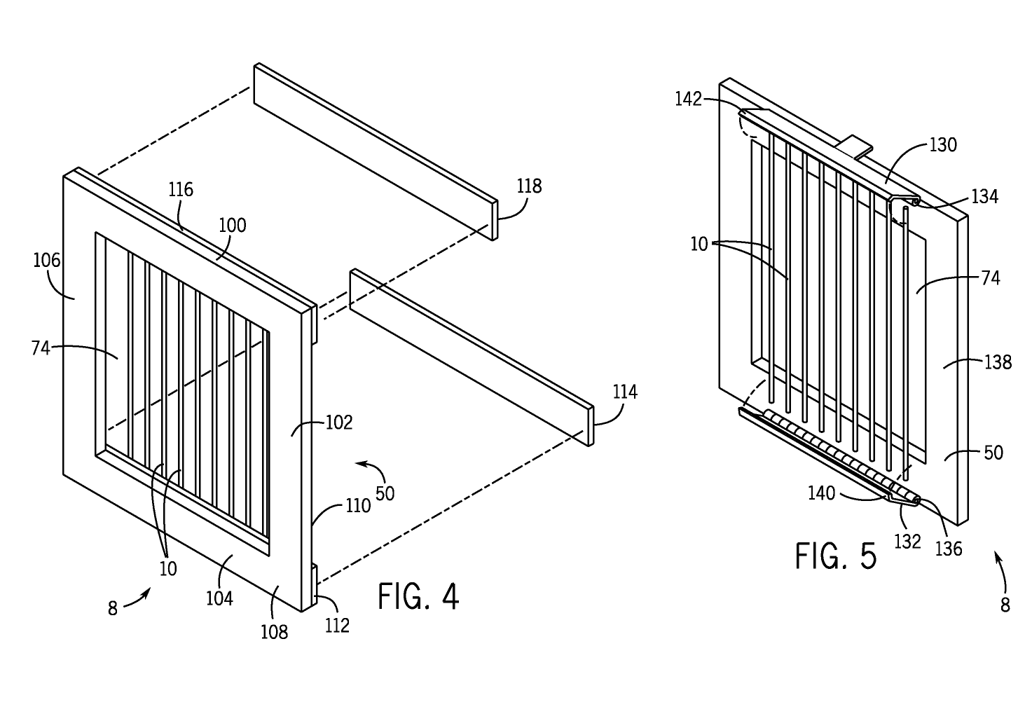

FIG. 4 is a front perspective view of an embodiment of a spray fixture system 8. In order to focus the electrically charged coating material towards the targets 10, the spray fixture system 8 includes a non-conductive frame 50 made out of a non-conductive material (e.g., non-electrically conductive, electrically insulative) such as a polymer, a wood, a ceramic, a non-conductive metal, a composite, or any combination thereof. For example, the polymer may include an elastomer or rubber, nylon, polyvinyl chloride (PVC), polystyrene, polyethylene, polypropylene, silicone, neoprene, or any combination thereof. The composite material may include a fiber reinforced polymer, a ceramic composite or other matrix material with a distributed reinforcing material (e.g., fibers). As illustrated, the frame 50 includes four integral sides 100, 102, 104, and 106 that define a square aperture 74. However, in other embodiments, the frame may form a different shape (e.g., a rectangle, square, triangle, circle, semi-circle, trapezoid, pentagon, etc.). In still other embodiments, the sides 100, 102, 104, and 106 may not be integral but may couple together to form the frame 50. The frame 50 defines a front face 108 and a rear face 110. In the present embodiment, a plurality of electrically conductive magnets 112, 114, 116, and 118 couple to the rear face 110 of the frame 50 to secure the targets 10 within the aperture 74. The conductive magnets 112 and 116 may couple directly to the frame 50 with an adhesive or with bolts, screws, pins, etc. The magnets 112 and 116 may attract the targets 10 aligning and holding the targets 10 within the aperture 74. The magnets 114 and 118 may then couple to the magnets 112 and 116 to compressively retain the targets 10 within the frame 74. In some embodiments, the conductive magnets 112 and 116 may not be conductive magnets, but maybe conductive members attracted to the magnets 114 and 118 or vice versa, enabling compressive retention of the targets 10. In the present embodiment, the magnets 112, 114, 116, and 118 are on the rear face 110 of the frame 50; however, in other embodiments the magnets 112, 114, 116, and 118 may be on the front face 108. When coupled to the front face, the magnets 114 and 118 may be non-conductive magnets to reduce electrical attraction to conductive members or magnets 112 and 116, while compressively retaining the targets 10 within the aperture 74.

FIG. 5 is a rear perspective view of an embodiment of a spray fixture system 8. The spray fixture system 8 includes spring-loaded clips 130 and 132. The clips 130 and 132 include respective spring-loaded hinges 134 and 136 that resiliently couple the clips 130 and 132 to a rear face 138 of the non-conductive frame 50. Thus, the spring-loaded clips 130 and 132 provide a biasing force (e.g., spring force) against the face 138 of the non-conductive frame 50, thereby creating a compressive force to retain the targets 10. As illustrated, the clips 130 and 132 couple to opposite sides of the non-conductive frame 50 around the aperture 74. The clips 130 and 132 enable retention of targets 10 within the aperture 74 during electrostatic spraying operations. The clips 130 and 132 may be conductive to enable charging or grounding of the targets 10 during spraying. However, in some embodiments, only one of the clips 130 or 132 may be conductive to facilitate grounding of the targets 10. As illustrated, the clips 130 and 132 rotate about their hinges 134 and 136 to open and close to secure the targets 10 within the aperture 74. In some embodiments, the clips 130 and 132 may include a soft conductive material along the clip edges 140 and 142 that enable the clips 130 and 132 to better secure and electrically couple to the targets 10.

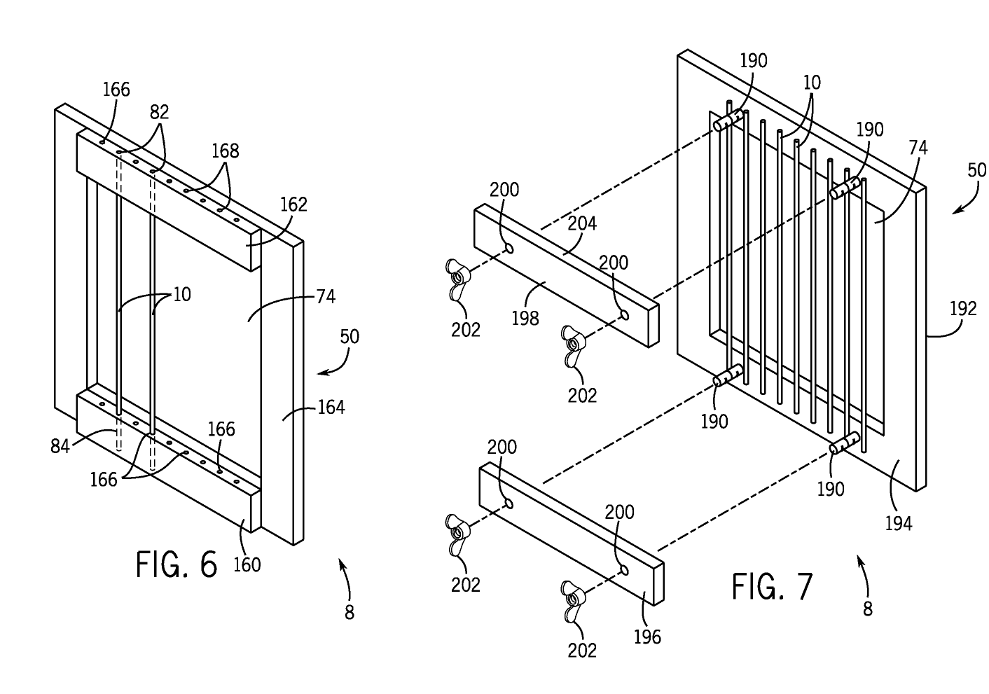

FIG. 6 is a rear perspective view of an embodiment of a spray fixture system 8. In FIG. 6, the spray fixture system 8 includes perforated blocks 160 and 162. The blocks 160 and 162 couple to a rear face 164 of the frame 50 on opposite sides of the aperture 74. During spraying operations, the blocks 160 and 162 retain the targets 10 within the aperture 74 ensuring that the targets 10 are electrostatically coated. The blocks 160 and 162 include respective blind holes 166 and passages 168 that may be aligned with one another and capable of receiving targets 10 and retaining the targets 10 within the aperture 74. Specifically, the passages 168 in block 162 enable the second ends 84 of the targets 10 to pass completely through the block 162 and into the blind holes 166 of the block 162. The blind holes 166 receive the second ends 84 retaining the targets 10 by blocking further movement of the second ends 84. In some embodiments, the blocks 160 and 162 may be made out of a magnetic material that attracts the targets 10, increasing the ability of the spray fixture system 8 to retain the targets 10. The magnetic material may be a conductive magnetic material that enables electric charging or grounding of the targets 10. In still other embodiments, only the block 160 may be magnetic and/or conductive, while the block 162 is made out of a non-conductive and/or non-magnetic material, to reduce electrical attraction.

FIG. 7 is a rear perspective view of an embodiment of a spray fixture system 8. The spray fixture system 8 includes the non-conductive frame 50 with threaded studs or bolts 190. The bolts 190 may be integral to the non-conductive frame or separately attachable. For example, the bolts 190 may extend through frame 50 through apertures in the front face 192 or the bolts 190 may be integrally formed as part of the frame and project from the rear face 194. The bolts 190 enable blocks 196 and 198 to couple to the frame 50, while securing the targets 10 in the aperture 74. The blocks 196 and 198 include apertures 200 that enable the bolts 190 to pass through the blocks 196 and 198. After receiving the bolts 190, the blocks 196 and 198 are compressively secured to the frame 50 with nuts 202 that thread onto the bolts 190. Either block 196 and/or block 198 may be made out of a conductive material that enables electric charging or grounding of the targets 10. Moreover, block 196 and/or block 198 may include a resilient or flexible layer 204. The flexible layer 204 (e.g., an elastomer, elastomer imbedded with metal particles, fabric, carbon filled resins, non-carbon filled resins) may be conductive or non-conductive to assist the blocks 196 and/or 198 in gripping and forming an electrical connection with the targets 10.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
an electrostatic spray fixture system, comprising:
a non-conductive frame surrounding an aperture, wherein the non-conductive frame is configured to retain an object within the aperture; and
a conductor coupled to the frame, wherein the conductor is configured to electrically couple to the object within the aperture, and the non-conductive frame comprises a non-conductive material to reduce electrostatic attraction of an electrically charged coating material.

2. The system of claim 1, comprising a first retaining member configured to retain the object.

3. The system of claim 2, comprising a second retaining member configured to retain the object.

4. The system of claim 3, wherein the first and second retaining members are coupled to opposite sides of the non-conductive frame.

5. The system of claim 3, wherein the first retaining member comprises a first non-conductive magnet, and the second retaining member comprises a second non-conductive magnet.

6. The system of claim 3, wherein the first retaining member comprises a first spring-loaded clip and the second retaining member comprises a second spring-loaded clip.

7. The system of claim 3, wherein the first retaining member comprises a first plate with a blind hole configured to block axial movement of the object, and the second retaining member comprises a second plate with a passage.

8. The system of claim 3, wherein the first retaining member comprises a first plate and the second retaining member comprises a second plate, wherein the first and second plates are configured to couple to bolts on the nonconductive frame.

9. The system of claim 8, wherein the first block is conductive.

10. A system, comprising:
an electrostatic spray fixture system, comprising:
a non-conductive frame surrounding an aperture;
a conductor coupled to the frame, wherein the conductor is configured to electrically couple to the object within the aperture, and the non-conductive frame comprises a non-conductive material to reduce electrostatic attraction of an electrically charged coating material; and
a first retaining member configured to retain the object within the aperture.

11. The system of claim 10, wherein first retaining member comprises the conductor.

12. The system of claim 10, wherein the first retaining member couples to the conductor.

13. The system of claim 10, wherein the first retaining member comprises a non-conductive magnet.

14. The system of claim 11, wherein the first retaining member comprises a spring-loaded clip.

15. The system of claim 10, comprising a second retaining member configured to retain the object within the aperture.

16. A system, comprising:
an electrostatic spray fixture, comprising:
a non-conductive frame surrounding an aperture, wherein the non-conductive frame is configured to retain an object within the aperture;
a conductor coupled to the frame, wherein the conductor is configured to electrically couple to the object within the aperture, and the non-conductive frame comprises a non-conductive material to reduce electrostatic attraction of an electrically charged coating material; and
a spindle electrically coupled to the conductor and configured to ground the conductor.

17. The system of claim 16, wherein the spindle couples to the non-conductive frame.

18. The system of claim 16, comprising a first retaining member configured to retain the object within the aperture.

19. The system of claim 18, comprising a second retaining member configured to retain the object within the aperture.

20. The system of claim 19, wherein the first and second retaining member are non-conductive.
